(19) United States
(12) Patent Application Publication
(10) Pub. No.: US 2021/0233470 A1
(43) Pub. Date: Jul. 29, 2021

(54) PIXEL DRIVING CIRCUIT, DISPLAY PANEL AND DRIVING METHOD THEREOF, AND DISPLAY DEVICE

(71) Applicants: HEFEI BOE OPTOELECTRONICS TECHNOLOGY CO., LTD., Hefei (CN); BOE TECHNOLOGY GROUP CO., LTD., Beijing (CN)

(72) Inventors: Jian Tao, Beijing (CN); Fengjing Tang, Beijing (CN); Wei Xue, Beijing (CN); Hongmin Li, Beijing (CN)

(21) Appl. No.: 17/059,813

(22) PCT Filed: Mar. 13, 2020
(86) PCT No.: PCT/CN2020/079265

§ 371 Date: Nov. 30, 2020

(30) Foreign Application Priority Data
Mar. 18, 2019 (CN) 201910211742.1

(51) Int. Cl. G09G 3/3233

(52) U.S. Cl. CPC G09G 3/3233; G09G 2320/0233; G09G 2310/0202; G09G 2300/0842; G09G 2300/0426

(57) ABSTRACT

A pixel driving circuit, a display panel and a driving method thereof, and a display device are provided, the pixel driving circuit including: a driving sub-circuit having a threshold voltage (Vth); a light emission control sub-circuit electrically coupled to the driving sub-circuit; and a data write sub-circuit electrically coupled to the driving sub-circuit and the light emission control sub-circuit, and electrically coupled with the driving sub-circuit at a first node and a second node, and configured to receive a scan signal and a data signal, to set a voltage of the first node to a voltage corresponding to the data signal, and set a voltage of the second node to the threshold voltage under control of the scan signal.

### CROSS-REFERENCE TO RELATED APPLICATION

This application is a Section 371 National Stage Application of PCT Application No. PCT/CN2020/079265, filed Mar. 13, 2020, entitled “PIXEL DRIVING CIRCUIT, DISPLAY PANEL AND DRIVING METHOD THEREOF, AND DISPLAY DEVICE”, which claims the benefit of Chinese Patent Application No. 201910211742.1 filed on Mar. 18, 2019, the disclosure of which is incorporated herein by reference in entirety.

### TECHNICAL FIELD

The disclosure relates to the field of display technology, in particular, to a pixel driving circuit, a display panel and a driving method thereof, and a display device.

### BACKGROUND

An OLED display device utilizes organic light emitting diodes for picture display, and has characteristic of low power consumption, a fast response speed, and an easy realization of a high-resolution display. However, as area of a display panel of an OLED display device increases, a display screen has a technical problem of uneven display gray.

### SUMMARY

The present disclosure provides a pixel driving circuit, a display panel and a driving method thereof, and a display device.

According to one aspect of the present disclosure, a pixel driving circuit is provided, which is configured to drive a light-emitting element to emit light, the pixel driving circuit comprising: a driving sub-circuit electrically coupled to the light-emitting element and configured to generate a driving current for causing the light-emitting element to emit light, the driving sub-circuit having a threshold voltage; a light emission control sub-circuit electrically coupled to the driving sub-circuit and the light-emitting element, and configured to receive a light emission control signal and to control the driving sub-circuit to output the driving current to the light-emitting element under control of the light emission control signal; and a data write sub-circuit electrically coupled to the driving sub-circuit and the light emission control sub-circuit, and electrically coupled with the driving sub-circuit at a first node and a second node, and configured to receive a scan signal and a data signal, and set a voltage of the first node to a voltage corresponding to the data signal, and set a voltage of the second node to the threshold voltage under control of the scan signal.

In some embodiments, the data write sub-circuit is electrically coupled with the light emission control sub-circuit at the first node, and the data write sub-circuit and the light emission control sub-circuit initializes the light-emitting element under control of the scan signal and the light emission control signal, respectively.

In some embodiments, the data write sub-circuit comprises a first transistor and a second transistor; wherein, a gate of the first transistor is electrically coupled to receive the scan signal, a first electrode of the first transistor is electrically coupled to receive the data signal, and a second electrode of the first transistor is electrically coupled to the first node; and a gate of the second transistor is electrically coupled to receive the scan signal, a first electrode of the second transistor is electrically coupled to the second node, and a second electrode of the second transistor is electrically coupled with the driving sub-circuit at a third node.

In some embodiments, the light emission control sub-circuit comprises a third transistor and a fourth transistor; wherein, a gate of the third transistor is electrically coupled to receive the light emission control signal, a first electrode of the third transistor is electrically coupled to receive a first supply voltage, and a second electrode of the third transistor is electrically coupled to the third node; and a gate of the fourth transistor is electrically coupled to receive the light emission control signal, a first electrode of the fourth transistor is electrically coupled to the first node, and a second electrode of the fourth transistor is electrically coupled to the light-emitting element.

In some embodiments, the driving sub-circuit comprises a driving transistor and a storage capacitor; wherein, a gate of the driving transistor is electrically coupled to the second node, a source of the driving transistor is electrically coupled to the light-emitting element, and a drain of the driving transistor is electrically coupled to the third node; wherein, a first end of the storage capacitor is electrically coupled to the first node, and a second end is electrically coupled to the second node.

In some embodiments, the driving current is K*(−Vdata)², wherein K is a constant related to the driving transistor, and Vdata is the data signal.

According to another aspect of the present disclosure, a display panel is provided, comprising: a scan signal line configured to provide a scan signal; a data signal line configured to provide a data signal and an initialization signal; a control signal line, configured to provide a light emission control signal; the pixel driving circuit according to the embodiments of the present disclosure; and a light-emitting element, a first end of which being electrically coupled to the pixel driving circuit, and a second end of which being electrically coupled to a second supply voltage.

According to another aspect of the present disclosure, a display device is provided, comprising the display panel according to the embodiments of the present disclosure.

According to another aspect of the present disclosure, a driving method of the display panel according to the embodiments of the present disclosure is provided, comprising: in a first period, providing a scan signal at a first level using the scan signal line, providing a light emission control signal at a first level using the control signal line, and providing an initialization signal using the data signal line; in a second period, providing a scan signal at a first level using the scan signal line, providing a light emission control signal at a second level using the control signal line, and providing a data signal using the data signal line; and in a third period, providing a scan signal at a second level using the scan signal line, and providing a light emission control signal at a first level using the control signal line.

In some embodiments, voltage of the data signal is less than voltage of the initialization signal.

In some embodiments, when the voltage of the initialization signal is zero and when a threshold voltage of the pixel driving circuit is greater than zero, the voltage of the data signal is negative.

In some embodiments, the voltage of the initialization signal is less than or equal to the second supply voltage.

### BRIEF DESCRIPTION OF THE DRAWINGS

The following description of the embodiments of the present disclosure in conjunction with the accompanying drawings will make above and other objectives, features, and advantages of the embodiments of the present disclosure clearer. It should be noted that throughout the drawings, the same elements are represented by the same or similar reference numbers, in which:

FIG. 1 shows a schematic structural diagram of a pixel driving circuit;

FIG. 2 shows an operation timing diagram of the pixel driving circuit in FIG. 1;

FIG. 3 shows a schematic structural diagram of a pixel driving circuit according to an embodiment of the present disclosure;

FIG. 4 shows a schematic circuit diagram of a pixel driving circuit according to another embodiment of the present disclosure;

FIG. 5 shows a schematic structural diagram of a display panel according to an embodiment of the present disclosure;

FIG. 6 shows a flowchart of a driving method of a display panel according to an embodiment of the present disclosure;

FIG. 7 shows a signal timing diagram of a driving method according to an embodiment of the present disclosure;

FIG. 8A shows an equivalent circuit diagram of a pixel driving circuit in a first period according to an embodiment of the present disclosure;

FIG. 8B shows an equivalent circuit diagram of a pixel driving circuit in a second period according to the embodiment of the present disclosure;

FIG. 8C shows an equivalent circuit diagram of a pixel driving circuit in a third period according to the embodiment of the present disclosure; and

FIG. 9 shows a schematic structural diagram of a display device according to an embodiment of the present disclosure.

### DETAILED DESCRIPTION OF EMBODIMENTS

In order to make objectives, technical solutions and advantages of the embodiments of the present disclosure clearer, the technical solutions in the embodiments of the present disclosure will be described clearly and completely in conjunction with the accompanying drawings in the embodiments of the present disclosure. Obviously, the embodiments described are part of the embodiments of the present disclosure, but not all of them. Based on the embodiments of the present disclosure described, all other embodiments obtained by those of ordinary skill in the art without creative labor are within the protection scope of the present disclosure. In the following description, some specific embodiments are only used for purpose of description, and should not be construed as limiting the present disclosure, but are merely examples of the embodiments of the present disclosure. When it may cause confusion in the understanding of the present disclosure, conventional structures or configurations will be omitted. It should be noted that a shape and size of each component in the drawings do not reflect an actual size and proportion, but merely illustrate the content of the embodiment of the present disclosure.

Unless otherwise defined, technical or scientific terms used in the embodiments of the present disclosure should have usual meanings understood by those skilled in the art. The “first”, “second” and similar words used in the embodiments of the present disclosure do not indicate any order, quantity or importance, but are only used to distinguish different components.

In addition, in the description of the embodiments of the present disclosure, the term “electrically coupled to” may mean that two components are directly electrically coupled, or may mean that two components are electrically coupled via one or more other components. In addition, these two components can be coupled or connected by wired or wireless means.

Depending on their functions, the transistors used in the embodiments of the present disclosure may include switching transistors and driving transistors. Both switching transistors and driving transistors may be thin film transistors or field effect transistors or other devices with the same characteristic. In the example of the present disclosure, the driving transistor is exemplified as an N-type driving transistor.

In the embodiments of the present disclosure, a source and a drain of the switching transistor are symmetrical, so the source and the drain can be interchanged. In the embodiments of the present disclosure, according to its function, a gate may be called as a control electrode, one of the source and the drain may be called as a first electrode, and the other of the source and the drain may be called as a second electrode. In the following examples, take the switching transistor being as an N-type thin film transistor as an example to describe. Those skilled in the art can understand that the embodiments of the present disclosure can obviously be applied to the case where the switching transistor is a P-type thin film transistor.

In addition, in the description of the embodiments of the present disclosure, the terms “first supply voltage” and “second supply voltage” are only used to distinguish different magnitude of two supply voltage. For example, in the following description, the “first supply voltage” is a relatively high voltage and the “second supply voltage” is a relatively low voltage. Those skilled in the art can understand that the present disclosure is not limited thereto.

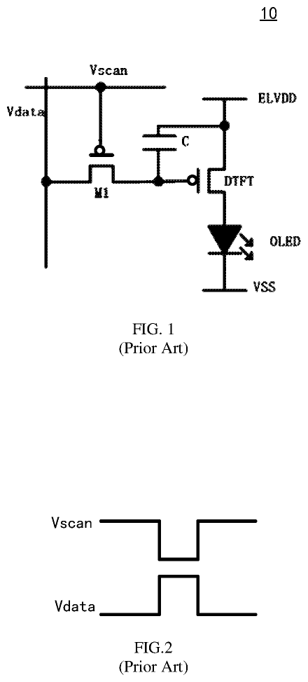

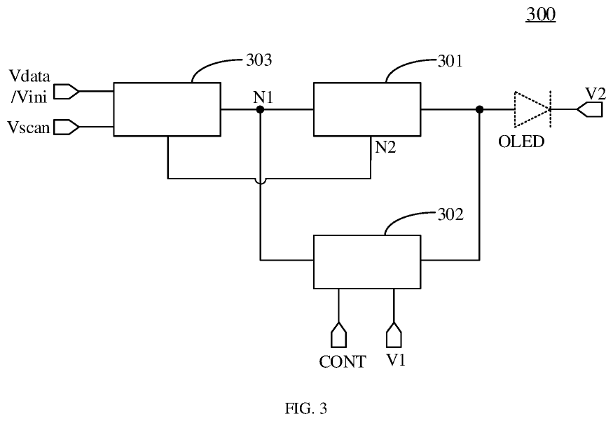

FIG. 1 shows a schematic structural diagram of a pixel driving circuit. FIG. 2 shows an operation timing diagram of the pixel driving circuit shown in FIG. 1, which shows a timing relationship between a scan signal received from a scan signal line and a data signal received from a data signal line. As shown in FIG. 1, the pixel driving circuit 10 is a 2T1C pixel driving circuit. The pixel driving circuit 10 includes a driving transistor DTFT, a switching transistor M1 and a storage capacitor C. In the example of FIG. 1, the driving transistor DTFT and the switching transistor M1 are both illustrated as P-type thin film transistors. When a certain row is strobed (i.e., scanning) by the scan signal line, the scan signal Vscan is a low-level signal, the switching transistor M1 is turned on, and the data signal Vdata is written into the storage capacitor C. When the scan of the line is over, Vscan turns into a high-level signal, the switching transistor M1 is turned off, and a gate voltage stored in the storage capacitor C drives the DTFT to generate a current to drive the OLED, ensuring that the OLED continues to emit light within one frame for display. A current formula for driving the thin film transistor DTFT is:

I_{oled}=K(Vgs−Vth)²,

herein, K is a parameter related to the process and design of the driving transistor DTFT. Once the driving transistor DTFT is manufactured, the parameter K is a constant, Vgs is a gate-source voltage of the driving transistor DTFT, and Vth is a threshold voltage of the driving transistor. In the example of the pixel driving circuit in FIG. 1, Vgs=Vdata−ELVDD, therefore, I_{oled}=K(Vdata−ELVDD−Vth)².

As can be seen from the current formula of the driving transistor DTFT above, in the OLED pixel driving circuit of FIG. 1, the current flowing through the driving transistor DTFT has a quadratic relationship with the threshold voltage Vth of the driving transistor DTFT and the supply voltage ELVDD coupled to a source of the DTFT. Therefore, if the Vth of the driving transistor DTFT between two pixel units has a difference of more than 0.1V, it will cause a significant deviation in the driving current, resulting in a corresponding difference in the brightness of the light-emitting element, and a residual image phenomenon in the display screen.

In addition, since the OLED pixel drive is driven by current, as an OLED is lightd, there is current for lighting the OLED on the ELVDD lead in a lighted pixel unit. During a light emission period of one frame, the driving current continuously flows through the ELVDD lead, and a voltage drop will occur as the transmission distance increases, resulting in uneven grayscale from a near end to a far end of the display screen, that is, a voltage drop of the ELVDD lead resistance. Therefore, reducing an ELVDD voltage fluctuation and reducing the voltage drop of the ELVDD lead resistance in the display panel are issues needing attention.

The embodiments of the present disclosure provide a pixel driving circuit structure, which can make current flowing through the driving transistor independent of both supply voltage and the threshold voltage of the driving transistor during a light emission phase of a display panel composed of the pixel driving circuit structure, thereby alleviating unevenness of the display screen due to threshold voltage drift of the driving transistor and voltage drop on a power supply lead, thereby improving display effect of the display panel.

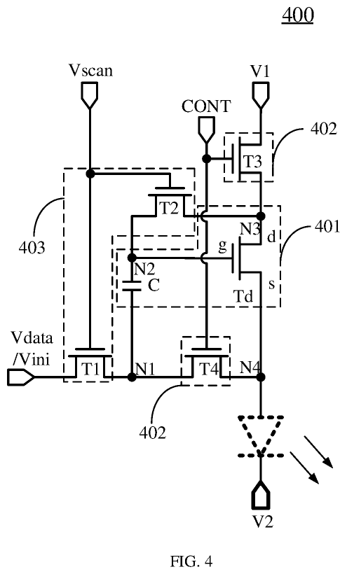

FIG. 3 shows a schematic structural diagram of a pixel driving circuit 30 according to an embodiment of the present disclosure. The pixel driving circuit 30 is configured to drive a light-emitting element 300 to emit light. According to the embodiment, the light-emitting element 300 may be an organic light emitting diode OLED, or may be other types of current-driven light-emitting elements. In order to illustrate connection relationship between the pixel driving circuit 30 and the light-emitting element 300, the light-emitting element 300 is shown in the form of a dotted line in FIG. 3.

As shown in FIG. 3, the pixel driving circuit 30 according to an embodiment of the present disclosure may include a driving sub-circuit 301 that is electrically coupled to the light-emitting element 300. The pixel driving circuit 30 may be configured to generate a driving current for causing the light-emitting element 300 to emit light, and have a threshold voltage. According to the embodiment, the threshold voltage may be a threshold voltage Vth of the driving transistor included in the pixel driving circuit 30.

The pixel driving circuit 30 according to the embodiment of the present disclosure may further include a light emission control sub-circuit 302. The light emission control sub-circuit 302 may be electrically coupled to the driving sub-circuit 301 and the light-emitting element 300. The light emission control sub-circuit 302 may be configured to receive a light emission control signal CONT, and to control the driving sub-circuit 301 to output a driving current related to the data signal Vdata to the light-emitting element 300 under control of the light emission control signal CONT.

The pixel driving circuit 30 according to an embodiment of the present disclosure may further include a data write sub-circuit 303. The data write sub-circuit 303 may be electrically coupled to the driving sub-circuit 301 and the light emission control sub-circuit 302, and electrically coupled with the driving sub-circuit 301 at a first node N1 and a second node N2. The data write sub-circuit 303 may be configured to receive the scan signal Vscan and the data signal Vdata, and to set a voltage of the first node N1 to a voltage corresponding to the data signal Vdata and set a voltage of the second node N2 to the threshold voltage Vth under control of the scan signal Vscan.

According to an embodiment of the present disclosure, the data write sub-circuit 303 is electrically coupled with the light emission control sub-circuit 302 at the first node N1. The data write sub-circuit 303 may also be configured to receive an initialization signal Vini. According to the embodiment, the data write sub-circuit 303 and the light emission control sub-circuit 302 use the initialization signal Vini to initialize the light-emitting element 300, respectively under control of the scan signal Vscan and the light emission control signal CONT.

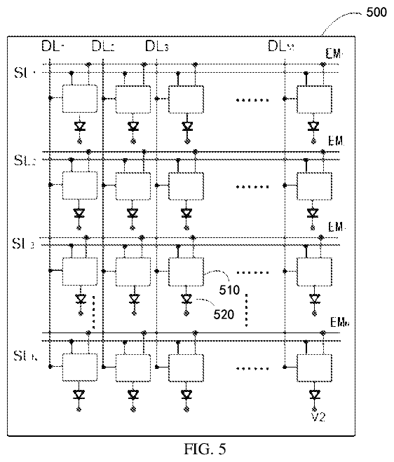

FIG. 4 shows a schematic circuit diagram of a pixel driving circuit according to another embodiment of the present disclosure. As shown in FIG. 4, the driving sub-circuit 401 may include a driving transistor Td and a storage capacitor C. According to an embodiment of the present disclosure, the driving transistor Td is an N-type thin film transistor. A gate g of the driving transistor Td is electrically coupled to a first end of the storage capacitor C, and is electrically coupled with a first end of the storage capacitor C at the second node N2. A source s of the driving transistor Td is electrically coupled to a first end of the light-emitting element OLED, and is electrically coupled with the first end of the light-emitting element OLED at a fourth node N4. A drain d of the driving transistor Td is electrically coupled to the light emission control sub-circuit 402, and is electrically coupled with the light emission control sub-circuit 402 at a third node N3.

The data write sub-circuit 403 may include a first transistor T1 and a second transistor T2. A gate of the first transistor T1 is electrically coupled to receive the scan signal Vscan, a first electrode of the first transistor T1 is electrically coupled to receive the data signal Vdata and the initialization signal Vini, and a second electrode of the first transistor T1 is electrically coupled with the driving sub-circuit 401 at the first node N1. For example, the second electrode of the first transistor T1 may be electrically coupled to the second end of the storage capacitor C. A gate of the second transistor T2 is electrically coupled to receive the scan signal Vscan, a first electrode of T2 is electrically coupled to the driving sub-circuit 401 at the second node N2, and a second electrode of T2 is electrically coupled with the driving sub-circuit 401 at the third node N3. For example, the first electrode of the second transistor T2 is electrically coupled to the gate of the driving transistor Td and the first end of the storage capacitor C, and the second electrode of which is electrically coupled to the drain of the driving transistor Td.

The light emission control sub-circuit 402 may include a third transistor T3 and a fourth transistor T4. As shown in FIG. 4, gates of the third transistor T3 and the fourth transistor T4 are electrically coupled to receive the light emission control signal CONT, a first electrode of the third transistor T3 is electrically coupled to receive a first supply voltage V1, and a second electrode of which is electrically coupled to the driving sub-circuit 401 at the third node N3. For example, the second electrode of the third transistor T3 may be electrically coupled to the drain of the driving transistor Td. A first electrode of the fourth transistor T4 is electrically coupled to the driving sub-circuit 401 at the first node N1, and a second electrode of which is electrically coupled to the light-emitting element. For example, the first electrode of the fourth transistor T4 may be electrically coupled to the second end of the storage capacitor C.

In the example of FIG. 4, the first transistor T1, the second transistor T2, the third transistor T3, and the fourth transistor T4 are all N-type transistors. Those skilled in the art can understand that according to the embodiments of the present disclosure, the first transistor T1, the second transistor T2, the third transistor T3, and the fourth transistor T4 may also be P-type transistors, as long as the level of the gate turn-on signal of each transistor is changed accordingly.

In addition, those skilled in the art can understand that the storage capacitor C can be implemented as a single capacitor or multiple capacitors coupled in parallel or in series, as long as corresponding functions can be realized.

According to an embodiment of the present disclosure, the pixel driving circuit 400 is coupled to the first end of the light-emitting element, and the second end of the light-emitting element may be electrically coupled to a second voltage V2. Those skilled in the art can understand that the second end of the light-emitting element OLED may be electrically coupled to a second voltage signal line that provides the second voltage V2, or may be coupled to ground. In the example of FIG. 4, the first end of the light-emitting element may be an anode of the OLED, and the second end of the light-emitting element may be a cathode of the OLED.

The pixel driving circuit structure provided by the embodiments of the present disclosure can make the current flowing through the driving transistor in the light emission phase of the light-emitting element independent of both supply voltage applied to the driving transistor and the threshold voltage of the driving transistor, thereby alleviating influence of both voltage drop on the power supply lead and the threshold voltage drift of the driving transistor on quality of the display screen. In addition, according to the embodiments of the present disclosure, by configuring a structure and an electrical connection relationship of a data sub-circuit and controlling a signal applied to the data sub-circuit, compensation function of the supply voltage and the threshold voltage of the driving transistor can be realized by a relatively simple circuit structure.

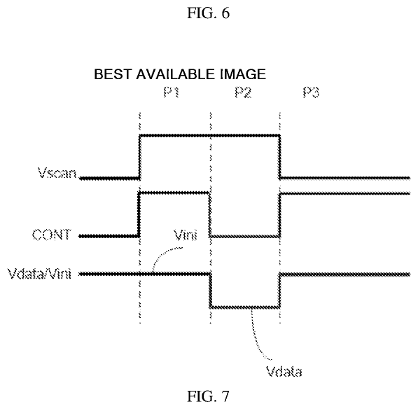

In other embodiments, a display panel composed of the pixel driving circuit according to the embodiments is also provided. FIG. 5 shows a schematic structural diagram of a display panel according to an embodiment of the present disclosure. As shown in FIG. 5, a display panel 500 according to an embodiment of the present disclosure may include scan signal lines SL₁˜SL_{N} configured to provide the scan signal Vscan; data signal lines DL₁˜DL_{M} configured to provide the data signal Vdata and the initialization signal Vini; and control signal lines EM₁˜EM_{N} configured to provide the light emission control signal CONT, where M and N are positive integers. The display panel 500 further includes the pixel driving circuit 510 and the light-emitting element 520 according to an embodiment of the present disclosure. The first end of the light-emitting element 520 may be electrically coupled to the pixel driving circuit 510, and the second end of the light-emitting element 520 may be electrically coupled to the second supply voltage V2.

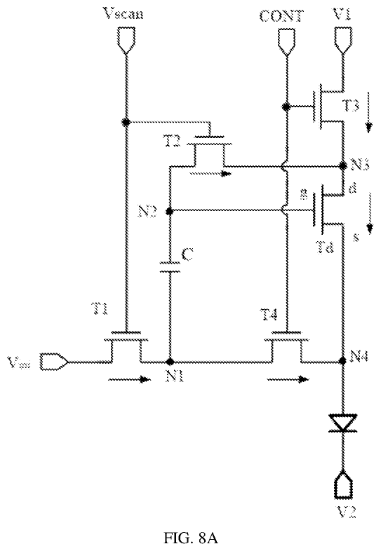

In other embodiments, a driving method of a display panel is also provided. FIG. 6 shows a flowchart of a driving method of a display panel according to an embodiment of the present disclosure. As shown in FIG. 6, a driving method 600 of a display panel according to an embodiment of the present disclosure may include the following steps. It should be noted that the sequence number of each step in the following method is only used as a representation of the step for description, and should not be regarded as indicating the execution order of various steps. Unless explicitly stated, the method need not be performed exactly in the order shown.

In step S601, in a first period, a scan signal at a first level is provided using the scan signal line, a light emission control signal at a first level is provided using the control signal line, and an initialization signal is provided using the data signal line.

In step S602, in a second period, a scan signal at a first level is provided using the scan signal line, a light emission control signal at a second level is provided using the control signal line, and a data signal is provided using the data signal line.

In step S603, in a third period, a scan signal of a second level is provided using the scan signal line, and a light emission control signal at a first level is provided using the control signal line.

According to an embodiment of the present disclosure, voltage of the data signal may be less than voltage of the initialization signal.

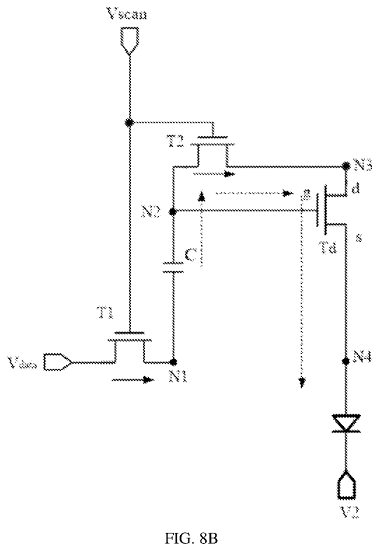

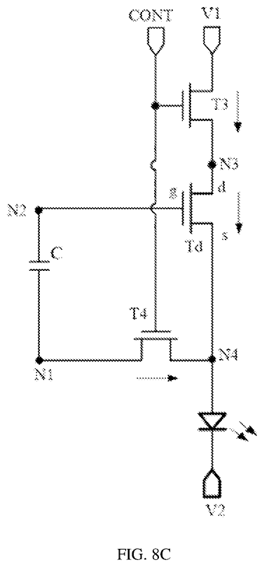

FIG. 7 shows a signal timing diagram of a driving method according to an embodiment of the present disclosure, FIG. 8A shows an equivalent circuit diagram of a pixel driving circuit in the first period according to an embodiment of the present disclosure, FIG. 8B shows an equivalent circuit diagram of the pixel driving circuit in the second period according to the embodiment of the present disclosure, and FIG. 8C shows an equivalent circuit diagram of the pixel driving circuit in the third period according to an embodiment of the present disclosure. Next, a driving method according to an embodiment of the present disclosure will be described in detail with reference to FIGS. 4, 5, 6, 7, 8A, 8B, and 8C.

As shown in FIG. 7, in the first period P1, the light emission control signal CONT is at the first level, and the scan signal Vscan is at the first level, and the first level may be, for example, a high level. Under control of the scan signal Vscan, the first transistor T1 and the second transistor T2 are turned on. Under control of the light emission control signal CONT, the third transistor T3 and the fourth transistor T4 are turned on. FIG. 8A shows an equivalent circuit diagram of the pixel driving circuit in the first period P1 according to an embodiment of the present disclosure.

As shown in FIGS. 7 and 8A, the initialization signal Vini is applied to the data write sub-circuit. In the first period P1, the first transistor T1 is turned on, and the fourth transistor T4 is turned on, thereby applying the initialization signal Vini to the fourth node N4 to initialize the voltage of the fourth node N4 to V_{N4}=Vini, thus the light-emitting element is initialized. Those skilled in the art can understand that the voltage of the initialization signal Vini can be set to (Vini-V2)<V_{oled}, wherein V2 is the voltage applied to the second end of the light-emitting element OLED, and V_{oled}, is a light-emitting threshold voltage of the light-emitting element OLED, thus it can ensure that the light-emitting element does not emit light in the first period P1. In an example where the second end of the light-emitting element is coupled to ground, that is, the second supply voltage V2 is zero, the voltage of the initialization signal Vini may be zero. The voltage of the second end of the storage capacitor C (shown as point N1 in the figure) is V_{N1}=Vini=V_{N4}.

As shown in FIG. 8A, the third transistor T3 is turned on, and the first supply voltage V1 is written into the third node N3. In an example where the driving transistor Td is an N-type transistor, the driving transistor Td is turned on. The second transistor T2 is turned on, and the voltage V_{N2} of the first end of the storage capacitor C, that is the end electrically coupled to the gate Td of the driving transistor (shown as point N2 in the figure), is the first supply voltage V1, that is, V_{N2}=V_{N3}=V1, so as to prepare for writing Vth into the storage capacitor C, wherein Vth is the threshold voltage of the driving transistor Td. At this time, the voltage across the storage capacitor C is V_{C}=V_{N2}−V_{N1}=V1−Vini.

Since an initialization of the pixel driving circuit is completed in the first period P1, the first period P1 may be referred to as an “initialization period”.

Next, as shown in FIG. 7, in the second period P2, the scan signal Vscan is at the first level, and the first transistor T1 and the second transistor T2 are turned on. The light emission control signal CONT is at the second level, and the second level may be, for example, a low level, and the third transistor T3 and the fourth transistor T4 are turned off.

FIG. 8B shows an equivalent circuit diagram of the pixel driving circuit in the second period P2 according to an embodiment of the present disclosure. As shown in FIGS. 7 and 8B, the data signal Vdata is applied to the data write sub-circuit in the second period P2. The first transistor T1 is turned on, so that the data signal Vdata is written into the first node N1, thus the voltage of the second end of the storage capacitor C is V_{N1}=Vdata. In an initial period of P2, since the voltage V_{N2} of the second node N2 remains at the first supply voltage V1, V_{N4}=Vini=0, and the driving transistor Td remains on, so that the storage capacitor C, the second transistor T2, the driving transistor Td and a pixel light-emitting layer of the light-emitting element OLED constitute a discharge path, as shown by dashed lines with arrows in FIG. 8B. Then the first end of the storage capacitor C, that is, the gate of the driving transistor Td (the second node N2 in FIG. 8B) starts to discharge, and potential of which starts to drop. As the voltage of the gate Vg=V_{N2} of the driving transistor Td drops from V1 until Vg=V_{N2}=V_{N4}+Vth, the driving transistor Td is turned off, wherein Vth is the threshold voltage of the driving transistor Td. When a balance is reached, the current in the discharge path is zero and V_{N4}=0, thus the voltage of the first end of the storage capacitor is V_{N2}=0+Vth=Vth. Therefore, the voltage across the storage capacitor C is V_{C}=V_{N2}−V_{N1}=Vth-Vdata.

In the second period P2, the data signal Vdata is actually written into the second end of the storage capacitor C, and the threshold voltage Vth of the driving transistor Td is written into the first end of the storage capacitor C. Therefore, the second period P2 can be referred to as a “data writing period”. It should be noted that, as shown in FIG. 7, the voltage of the data signal Vdata according to an embodiment of the present disclosure may be less than the voltage of the initialization signal Vini. For example, when the initialization signal Vini is zero, the voltage of the data signal Vdata may be a negative voltage.

Next, in the third period P3, the scan signal Vscan is at the second level, the light emission control signal CONT is at the first level, the first transistor T1 and the second transistor T2 are turned off, and the third transistor T3 and the fourth transistor T4 are turned on.

FIG. 8C shows an equivalent circuit diagram of the pixel driving circuit in the third period P3 according to an embodiment of the present disclosure.

As shown in FIG. 8C, in the third period P3, the third transistor T3 is turned on, thereby the voltage of the drain of driving the transistor Td is V_{d}=V_{N3}=V1. The fourth transistor T4 is turned on, and V_{N4}=V_{N1}. Therefore, a gate-source voltage of the driving transistor Td is Vgs=V_{N2}−V_{N4}=V_{N2}−V_{N1}=Vth-Vdata. Since the data signal Vdata is a negative voltage, Vgs=Vth−Vdata=Vth+|Vdata|>Vth, wherein |Vdata| is an absolute value of Vdata, thus the driving transistor Td is turned on. According to I_{DS}=K(V_{gs}−Vth)², it can be concluded that the driving current flowing through the driving transistor Td is:

I_{DS}=K(Vth−Vdata−Vth)²=K(−Vdata)².

As described above with reference to FIG. 1, K is a parameter related to the process and design of the driving transistor Td. Once the driving transistor Td is manufactured, the parameter K is a constant.

After that, the light emission control signal CONT remains at a high level, so that the driving current I_{oled} corresponding to the data signal Vdata continues to flow through the light-emitting element OLED, to drive the light-emitting element OLED to keep emitting light until the data write sub-circuit receives a next scan signal Vscan. Since the light-emitting element OLED is driven to emit light in the third period P3, the third period P3 may be referred to as a “light emission period”.

It can be seen that above current I_{DS} has nothing to do with both the voltage of the drain V1 of the driving transistor Td and the threshold voltage Vth of the driving transistor Td. Therefore, the pixel driving circuit according to the embodiment of the present disclosure can compensate the threshold voltage Vth and the voltage of the drain V1 of the driving transistor Td.

According to the structure of the pixel driving circuit of the embodiment of the present disclosure, the current flowing through the driving transistor in the third period P3 is independent of the supply voltage and the threshold voltage of the driving transistor, thereby alleviating the influence of both the voltage drop on the power supply lead and the threshold voltage drift of the driving transistor on the quality of the display screen. In addition, according to the embodiments of the present disclosure, by configuring the structure and electrical connection relationship of the data sub-circuit and controlling the signal applied to the data sub-circuit, compensation function of the supply voltage and the threshold voltage of the driving transistor can be realized by a relatively simple circuit structure.

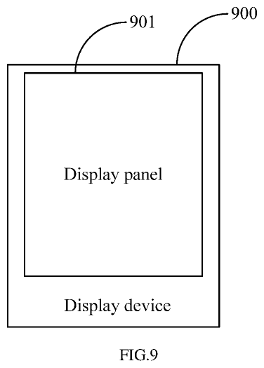

According to an embodiment of the present disclosure, a display device is also provided. FIG. 9 shows a schematic structural diagram of a display device 900 according to an embodiment of the present disclosure. As shown in FIG. 9, a display device 900 according to an embodiment of the present disclosure may include a display panel 901 according to an embodiment of the present disclosure. The display device 900 according to the embodiment of the present disclosure may be any product or component with a display function, such as electronic paper, mobile phone, tablet computer, television, display, notebook computer, digital photo frame, navigator, etc.

It should be noted that in the above description, the technical solutions of the embodiments of the present disclosure are shown only by way of example, but it does not mean that the embodiments of the present disclosure are limited to the above steps and structures. Where possible, the steps and structure can be adjusted and selected as needed. Therefore, some steps and units are not essential elements for implementing the overall inventive idea of the embodiments of the present disclosure.

So far, the present disclosure has been described in conjunction with the preferred embodiments. It should be understood that those skilled in the art can make various other changes, substitutions and additions without departing from the spirit and scope of the embodiments of the present disclosure. Therefore, the scope of the embodiments of the present disclosure is not limited to the above specific embodiments, but should be defined by the appended claims.

1. A pixel driving circuit configured to drive a light-emitting element to emit light, the pixel driving circuit comprising:
a driving sub-circuit electrically coupled to the light-emitting element and configured to generate a driving current for causing the light-emitting element to emit light, the driving sub-circuit having a threshold voltage;
a light emission control sub-circuit electrically coupled to the driving sub-circuit and the light-emitting element, and configured to receive a light emission control signal and control the driving sub-circuit to output the driving current to the light-emitting element under control of the light emission control signal; and
a data write sub-circuit electrically coupled to the driving sub-circuit and the light emission control sub-circuit, and electrically coupled with the driving sub-circuit at a first node and a second node, and configured to receive a scan signal and a data signal, and set a voltage of the first node to a voltage corresponding to the data signal, and set a voltage of the second node to the threshold voltage under control of the scan signal.

2. The pixel driving circuit according to claim 1, wherein the data write sub-circuit is electrically coupled with the light emission control sub-circuit at the first node, and the data write sub-circuit and the light emission control sub-circuit initializes the light-emitting element under control of the scan signal and the light emission control signal, respectively.

3. The pixel driving circuit according to claim 2, wherein the data write sub-circuit comprises a first transistor and a second transistor; wherein
a gate of the first transistor is electrically coupled to receive the scan signal, a first electrode of the first transistor is electrically coupled to receive the data signal, and a second electrode of the first transistor is electrically coupled to the first node; and
a gate of the second transistor is electrically coupled to receive the scan signal, a first electrode of the second transistor is electrically coupled to the second node, and a second electrode of the second transistor is electrically coupled with the driving sub-circuit at a third node.

4. The pixel driving circuit according to claim 3, wherein the light emission control sub-circuit comprises a third transistor and a fourth transistor; wherein
a gate of the third transistor is electrically coupled to receive the light emission control signal, a first electrode of the third transistor is electrically coupled to receive a first supply voltage, and a second electrode of the third transistor is electrically coupled to the third node; and
a gate of the fourth transistor is electrically coupled to receive the light emission control signal, a first electrode of the fourth transistor is electrically coupled to the first node, and a second electrode of the fourth transistor is electrically coupled to the light-emitting element.

5. The pixel driving circuit according to claim 4, wherein the driving sub-circuit comprises a driving transistor and a storage capacitor; wherein
a gate of the driving transistor is electrically coupled to the second node, a source of the driving transistor is electrically coupled to the light-emitting element, and a drain of the driving transistor is electrically coupled to the third node; and
a first end of the storage capacitor is electrically coupled to the first node, and a second end is electrically coupled to the second node.

6. The pixel driving circuit according to claim 5, wherein the driving current is K*(−Vdata)², wherein K is a constant related to the driving transistor, and Vdata is the data signal.

7. A display panel, comprising:
a scan signal line configured to provide a scan signal;
a data signal line configured to provide a data signal and an initialization signal;
a control signal line configured to provide a light emission control signal;
the pixel driving circuit according to claim 1; and
a light-emitting element, a first end of which being electrically coupled to the pixel driving circuit, and a second end of which being electrically coupled to a second supply voltage.

8. A driving method of the display panel according to claim 7, comprising:
in a first period, providing a scan signal at a first level using the scan signal line, providing a light emission control signal at a first level using the control signal line, and providing an initialization signal using the data signal line;
in a second period, providing a scan signal at a first level using the scan signal line, providing a light emission control signal at a second level using the control signal line, and providing a data signal using the data signal line; and
in a third period, providing a scan signal at a second level using the scan signal line, and providing a light emission control signal at a first level using the control signal line.

9. The driving method according to claim 8, wherein voltage of the data signal is less than voltage of the initialization signal.

10. The driving method according to claim 8, wherein when the voltage of the initialization signal is zero and when a threshold voltage of the pixel driving circuit is greater than zero, the voltage of the data signal is negative.

11. The driving method according to claim 8, wherein the voltage of the initialization signal is less than or equal to the second supply voltage.
